(19) United States
(12) Patent Application Publication
(10) Pub. No.: US 2011/0225072 A1
(43) Pub. Date: Sep. 15, 2011

(54) AUTOMATED UTILITY METERING SYSTEMS AND METHODS

(76) Inventor: Ronald R. SEWELL, Alpharetta, GA (US)

(21) Appl. No.: 13/044,282

(22) Filed: Mar. 9, 2011

Related U.S. Application Data
(60) Provisional application No. 61/311,934, filed on Mar. 9, 2010.

(51) Int. Cl. G06Q 30/00; G06Q 10/00

(52) U.S. Cl. 705/30

(57) ABSTRACT

Utility metering systems and methods are disclosed. An exemplary utility metering system can comprise a middleware system and a plurality of firmware systems. Each firmware system can be installed at a utility meter. A firmware system can maintain data related to an associated customer's utility services account. The firmware system can perform real time calculations to update the customer's account and balance as needed and can make decisions related to the customer's account, such as connection and disconnection of services, which can be implemented in real time. The middleware system can enable customers to interact with their respective utility meters, so that modifications made by the customers to their accounts can be transmitted to the applicable utility meters in real time.

### CROSS-REFERENCE TO RELATED APPLICATIONS

This application claims a benefit under 35 U.S.C. §119(e) of U.S. Provisional Application Ser. No. 61/311,934, filed 9 Mar. 2010, the entire contents and substance of which are hereby incorporated by reference as if fully set out below.

### TECHNICAL FIELD

Various embodiments of the present invention relate to utility metering systems and methods and, more particularly, to automated utility metering systems and methods comprising automated customer services and intelligent meters configured to maintain account data at the customer premise.

### BACKGROUND

Pre-pay services have become one of the hottest topics in the utility industry today. Customers are increasingly having a difficult time keeping up with rising costs, including their utility bills. To compound this challenge, the price of electricity is continuing to climb.

Pre-pay allows customers to subscribe to utility services without having to pay a deposit and without utility providers risking nonpayment. With pre-pay, a customer controls when and how much is paid for a utility, and the utility service is provided after payment, consequently giving the customer improved management over the utility account. Conventional pre-pay utility systems generally fall into two categories, token systems and settlement systems.

In token systems, an electricity meter is in communication with an electronic card reader in the customer's home. The customer can have an electronic card that stores data relating to pre-payments, such as in a magnetic strip on the card. The customer can add value to the card by inserting the card into payment machines located at convenience stores or similar locations. The customer can insert the card into the card reader. The card reader then relays the credit balance information to the electricity meter, thereby allowing the meter to count down the available kilowatt hours.

In a settlement system, a billing system at a middleware system receives periodic readings from each electricity meter. When a reading received at the middleware system, the server calculates an estimated remaining number of kilowatt hours remaining from customers' pre-payments. This method operates “after the fact” and thus requires an estimated number of days left on the customer's account. With the settlement approach, it is possible for a customer to use more than the allotted number of kilowatt hours, simply as a result of the system failing to accurately estimate the remaining number of available hours. Additionally, with this latter approach, the server must meet a high burden of performing calculations for all of the customer accounts. This can require hours of downtime each night, as the middleware system performs these calculations.

### SUMMARY

There is a need for utility metering systems and methods that reduce server workload and provide automated customer services, such as inquiries, billing, and account management. It is to such utility metering systems and methods that various embodiments of the present invention are directed.

Briefly described, a utility metering system can comprise a middleware system and a plurality of firmware systems located at utility meters. Each firmware system can be provided on or proximate a utility meter associated with a customer and usually located at a customer premise. The firmware system can comprise various data relating to the customer's account, including pre-pay balance, rate schedule, and meter rules. In some embodiments, the firmware system can be configured to calculate the customer's balance at the customer premise and to make decisions about the customer's utility account.

The middleware system can be in communication with a plurality of the firmware systems, each located on a separate utility meter at an individual customer site. The various firmware systems can perform many of the operations traditionally performed by a central server of a utility provider. By relocating these services to local devices at the customer premise, the utility metering system can not only reduce workload at the middleware system, but can also provide additional services that are not available in conventional utility systems. The middleware system can perform central services, such as those related to multiple utility accounts, and can also manage and communicate with system resources used by the utility metering system. For example, and not limitation, the middleware system can provide a website through which customers can manage their accounts. Through the website serviced by the middleware system, the customers can make changes to the firmware systems at their utility meters on the customer premises.

In some embodiments, the utility metering system can comprise a processor interface coupled to a utility meter and to a utility supply line; a processor and firmware system operatively coupled to said processor interface; a wireless communications transceiver coupled to said processor and firmware system and said processor interface; wherein said firmware includes a plurality of modules to provide control of automated responses to utility service requests from both customers and utility service providers. In another aspect, there is provided a utility metering subsystem comprising a middleware system coupled between said wireless communication transceiver and said firmware for translating utility service requests and responses thereto formatted in disparate data protocols.

An exemplary utility metering system of the present invention can integrate seamless data communication between a wide variety of known modular utility metering applications to provide a full-function link with an automated metering infrastructure (“AMI”) and with a utility front office. The utility metering system can include a comprehensive suite of firmware and middleware software applications integrated with a communications and interface system. The utility metering system can minimize or reduce the need for human customer service intervention in facilitating data transfer and account management, leading to improved efficiencies and lower costs for utility providers.

An exemplary utility metering method can comprise receiving a utility service request from a customer or utility provider through a communication interface coupled between an intelligent utility metering system on a customer premise and a data terminal of a utility provider; parsing the request and translating the request from originating data protocol into a common internal protocol; processing the request in a processor in the utility metering system to produce a response; translating the response into a data protocol of a destination recipient; and transmitting the response to the destination recipient.

The utility metering systems and methods can thus enable efficient and cost-effective utility metering. The above and other objects, features, and advantages of the utility metering systems and methods will become more apparent upon reading the following specification in conjunction with the accompanying drawing figures.

### BRIEF DESCRIPTION OF THE FIGURES

FIG. 1 illustrates a diagram of a utility metering system, according to an exemplary embodiment of the present invention.

FIG. 2 illustrates a detailed view of a utility meter and firmware system of the utility metering system, according to an exemplary embodiment of the present invention.

FIG. 3 illustrates a diagram of a middleware system of the utility services system in communication with one or more system resources, according to an exemplary embodiment of the present invention.

FIG. 4 illustrates a utility metering method, according to an exemplary embodiment of the present invention.

### DETAILED DESCRIPTION

To facilitate an understanding of the principles and features of the present invention, various illustrative embodiments are explained below. In particular, the invention is described in the context of being a utility metering system providing efficient and automated account services by providing local operations on or proximate an electricity meter at a customer premise. Embodiments of the invention, however, are not limited to this context. Rather, embodiments of the invention can be utilized to provide automated services in various contexts and for various types of utilities and utility meters.

The materials and components described hereinafter as making up various elements of the invention are intended to be illustrative and not restrictive. Many suitable materials and components that can perform the same or similar functions as materials and components described herein are intended to be embraced within the scope of the invention. Such other materials and components that are embraced but not described herein can include, without limitation, similar or analogous materials or components developed after development of the invention.

Various embodiments of the present invention are utility metering systems and methods to facilitate efficient, automated operations. Referring now to the figures, in which like reference numerals represent like parts throughout the views, various embodiments of the utility metering systems and methods will be described in detail.

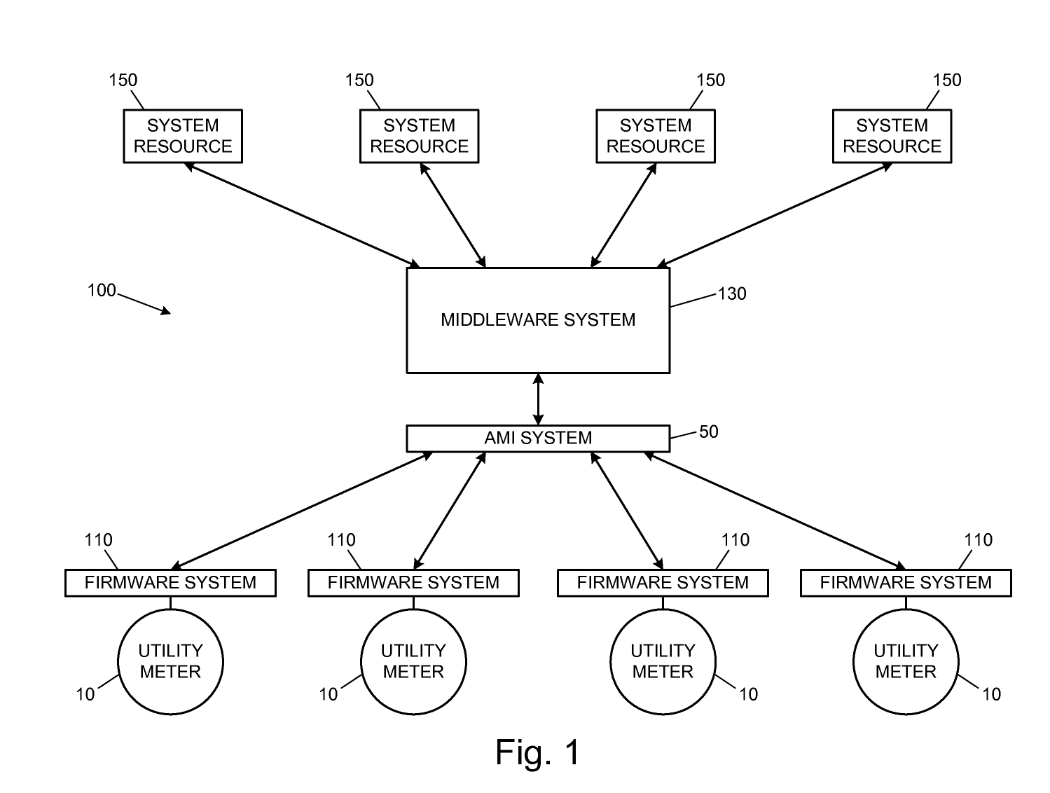

FIG. 1 illustrates a utility metering system, according to an exemplary embodiment of the present invention. In an exemplary embodiment, the utility metering system 100 can comprise a middleware system 130, one or more firmware systems 110 at utility meters 10, and optional one or more system resources 150. In an exemplary embodiment, the utility metering system 100 can be installed atop an automated metering infrastructure (“AMI”) 50, which, in conjunction with the middleware system 130, can facilitate communications between the middleware system 130 and the firmware systems 110 at the utility meters 10.

As shown in FIG. 1, a firmware system 110 can be installed on or proximate a utility meter 10 at a customer premise, so as to control or coordinate with the utility meter 10 without intervention from a central server of the utility metering system 100. It will be understood that “customer premise” refers to a location in, on, or around a customer's location of service, such as a home, house, apartment, dwelling, office, business, or other site of the customer.

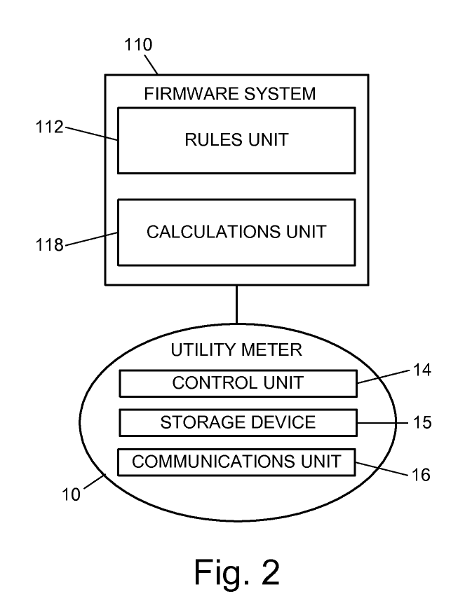

FIG. 2 illustrates a more detailed diagram of the utility meter 10 and the firmware system 110, according to an exemplary embodiment of the present invention. As shown in FIG. 2, the firmware system 110 can comprise one or more units configured to access data on the utility meter 10, to control the utility meter 10, and to communicate with the middleware system 130 through the AMI system 50. The units of the firmware system 110 can include a rules unit 112 and a calculations unit 118. The firmware system 110 can also utilize a control unit 14, a communications unit 16, and a storage device, one or all of which can be incorporated in the utility meter 10. In some exemplary embodiments, the control unit 14, the communications unit 16, and the storage device 15 can be integrated into the utility meter 10 and can be accessible by the firmware system 110, but in other exemplary embodiments, these units 14 and 16 may alternatively be part of the firmware system 110 itself.

The units of the firmware system 110 can be hardware, software, or a combination thereof. Although the units are described herein as being distinct from one another, this description is provided only for illustrative purposes only, to explain the various functionalities of the firmware system 110 as a whole. It will thus be understood that hardware or software incorporated into these units need not be separated into distinct components for the units described.

Generally, the storage device 15 can store data related to the customer's account; the rules unit 112 can maintain rules for decision-making on or proximate the utility meter 10 at customer premise; the calculations unit 118 can perform calculations for management of the customer's account; the control unit 14 can track utility usage and control the hardware of the utility meter 10, such as connection and disconnection of utility services. These units can be in communication with one another for operation of the firmware system 110. Through its various units, the firmware system 110 can maintain and manage information about the associated customer's account.

In some embodiments, the firmware system 110 can independently make decisions at the customer premise, without case-by-case approval from a central server. Conventional utility systems enable utility meters only to count utility usage and to respond to server requests for usage updates. In contrast, in various embodiments of the present invention, the firmware system 110 at the customer premise can have independent decision-making capability. For example, the firmware system 110 can calculate service costs and credits used, calculate real time balances, initiate customer notifications, turn service off when the balance drops below a threshold, turn service on when a payment is received, and even independently decide when one or all of these tasks are needed. As a result, the utility metering system 100 can provide an increased number and quality of automated services, can more efficiently manage customer accounts, and can be enabled to manage a greater total number of customer accounts because of reduced burden on a central server and/or upstream network nodes.

In conventional systems, account calculations are generally performed at predetermined intervals, such as once per day for each customer account. In a conventional system, a central server contacts each utility meter requesting a usage update, and in response, the utility meter transmits the usage update to the central server. The utility system can be associated with hundreds of thousands of utility meters. Because account data must be received by the central server from each utility meter once per day, the central server is bombarded with data from the many utility meters in the system. After receiving the data, the central server must perform the calculations for each and every utility meter to update the account balances. As a result, available bandwidth to and from the central server in a conventional system is severely limited, and the central server itself will often experience downtimes while processing data. Additionally, because calculations are performed only once per day for each utility meter 10, the conventional system enables customers to exceed their available credits between account updates. Embodiments of the present invention can overcome these problems by enabling calculations and decision-making to be performed by the firmware system 110 at the customer premise.

In an exemplary embodiment of the present utility metering system 100, data can be maintained and managed by the firmware system 110 at the utility meter 10, and thus calculations related to the customer's account can be performed in real-time at the customer premise. For example, the storage device 15 can maintain information about the customer's rate plan, and the control unit 14 can track utility usage. At predetermined intervals or according to a predetermined schedule, the calculations unit 118 can update the customer's account balance based on the rate plan and the utility usage. These account updates can be performed at intervals of 5 seconds, 30 seconds, one minute, or other appropriate timeframe selected to balance workload with accuracy. In an exemplary embodiment, the account updates are performed at regular intervals of approximately one minute or less. Thus, the account balance on the firmware system 110 can be updated in real time, so as to reduce or minimize utility usage in excess of that for which the customer prepaid.

The rules unit 112 can maintain and apply a set of one or more rules that can determine decisions made by the firmware system 110. A rule can define how the firmware system 110 responds when a predetermined threshold condition is met. When the firmware system, 110 is initially installed on a utility meter 10, the rules unit 112 can use a default set of rules. Through an exemplary embodiment of the middleware system 130 after initial installation, service representatives or the customer can update the rules to suit the utility provider and the customer's preferences. The rules maintained by the rules unit 112 at each firmware system 110 can vary across different utility meters 10, so as to be customized to each customer.

In general, a rule can define how the firmware system 110 modifies the customer's account when a predetermined condition, such as a threshold, is met. The rules unit 112 can maintain the predetermined conditions and determine when a condition is met, so that the applicable rule can be applied to the customer's account.

A condition for a rule can relate to, for example, remaining account balance in dollars or service units (e.g., kilowatt hours of electricity), estimated remaining duration of prepaid service, time of day, date, weather conditions, rate plan changes, other account changes, or various other aspects related to utility services or account management. When a condition for a rule is met, the rules unit 112 can cause the firmware system 110 to make a decision as to what action to take in response to the threshold condition, where the decision made is determined by the rule.

A decision for a rule can be, for example, a decision to disconnect service, connect service, increase or decrease the account balance, maintain service despite account balance, or various other modifications to the customer's account.

For examples: (1) a rule may state that the firmware system 110 is to disconnect service when the threshold condition of a zero balance is met; (2) a rule may state that the firmware system 110 is to notify a service representative when a zero balance is achieved; (3) a rule may state that the firmware system 110 is to reconnect service when the account balance exceeds zero; or (4) a rule may state that the firmware system 110 is to notify the customer when the account balance is less than or meets a predetermined low balance. It will be understood that various other rules can be established and used by the firmware system.

In some embodiments, the rules unit 112 can prioritize the rules in a manner indicated by the utility service system 100. For example, a rule can be established to require that when the firmware system 110 is notified of severe weather conditions, utility service is to be maintained and not disconnected until receiving notification that the severe weather has ended. This rule may be given higher priority than a rule indicating that service is to be automatically disconnected when a zero balance is reached. As a result, utility services can be maintained during severe weather even if a zero balance is reached. Rule priorities can be used for various reasons, such as to create exceptions or to comply with regional regulations for utility service provision.

Included among the rules on a particular firmware system 110 at a utility meter 10 can be one or more rate rules. A rate rule can define how a customer is charged for utility usage. As mentioned above, the calculations unit 118 can keep the customer's account balance updated in real time on the firmware system 110. A rate rule can be based on rate options selected for the customer's account, which options may be modifiable through the middleware system 130. When the control unit 112 determines that services have been used, a rate rule can be applied to update the customer's account balance. The current rate rule of an exemplary embodiment can reflect the active rate plan for the customer's account. Available rate plans can include the following, as examples: fixed rate, variable rate, fixed tiered, variable tiered, fixed time-of-use dependent, or variable time-of-use dependent. It will be understood, of course, that other rate plans can be utilized as well.

Because the firmware system 110 can also maintain the current account balance of the associated customer, the firmware system 110 can update that balance by subtracting the cost to the customer of used utility services. Accordingly, each firmware system 110, and thus each utility meter 10, can track the current balance of the associated customer at the customer premise. This feature of the present invention can drastically reduce the burden on the middleware system 130, which would traditionally perform these calculations for each and every utility meter 10 and associated customer. Further, these calculations are traditionally performed periodically, such as on a nightly basis, thus unwittingly allowing a customer to use services that have not yet been paid for. In contrast, in an exemplary embodiment of the utility metering system 100, each firmware system 110 can update the associated customer's account balance in real time, enabling the utility metering system 100 to react to changed circumstances in a timely manner. Embodiments of the present utility services system 100 are also easily scalable, as a result of the decreased burden on a central system.

To maintain current records at the middleware system 130, the firmware system 110 can regularly and, in some embodiments, autonomously back up its data by transmitting a log to the middleware system 130. These backup can occur according to rules (e.g., at certain account balances or usage points) or on a predetermined periodic basis. Backing up the firmware system 110 data can reduce the risks associated with potential data loss and with tampering of the utility meter 10.

An alternative exemplary embodiment of the utility metering system 100 can include a less comprehensive firmware system 110 at a utility meter 10. The less comprehensive firmware system 110, which will be referred to herein as a “thin” version of the firmware system 110, can be used throughout the utility services system 100 as an alternative to the “thick” version, or can be used for one or more utility meters 10 in the same utility services system 100 that uses the thick version in other utility meters 10. In other words, the utility services system 100 can utilize only thin versions of the firmware system 110, only thick versions of the firmware system 110, of a combination of both versions.

In the thin version, an exemplary embodiment of the firmware system 110 does not perform complex calculations or make decisions based on these calculations. Such a thin firmware system 110 can instead simply notify the middleware system 130 when a threshold condition, or set point, is met. In this embodiment, a threshold condition can be met, for example, when the control unit 14 indicates that a predetermined amount of the utility service (e.g., kilowatt hours) have been used. When a set point is met, the firmware system 110 can notify the middleware system 130. If multiple set points are available, the firmware system 110 can also notify the middleware system 130 of which set point was met. After receiving the notification, the middleware system 130 can perform the necessary calculations, if any, and apply one or more rules to determine how to respond. Rules used by the middleware system 130 in this thin embodiment can be similar to the rules used in the thick embodiment described above, except that calculations can be performed at the middleware system 130. In other words, this embodiment of the utility metering system 100 can be similar to the previously described embodiment, except that a greater degree of the calculations and decisions for each customer account can be made at the middleware system 130 instead of at each individual utility meter 10.

Because conventional pre-pay system perform scheduled periodic calculations, conventional systems risk providing utility services to pre-pay customers even after the prepaid value has run out. Embodiments of the present invention, including both the thin and thick versions, are improvements over conventional systems in that the present invention can react to usage in real time. With the thick firmware system 110, calculations can be performed and the account balance can be updated at the utility meter 10 in real time. In the thin firmware system 110, the set points can be set based on the customer's account. For example, the middleware system 130 can determine or estimate how many usage units are available to a customer based on pre-payments, and the determined usage units can be used to calculate appropriate set points for the firmware system 110. For example, and not limitation, if the middleware system determines that the customer's payments cover X kilowatt hours of electricity, then the middleware system 130 can instruct the firmware system 110 to notify the middleware system 130 when X further kilowatt hours are used.

Referring back to FIG. 1, as shown, the utility metering system 100 can be installed or built on top of an AMI system 50. The AMI system 50 can be previously configured to pass standard messages between the utility meter 10 and a third party, which in this case, can be the middleware system 130. The utility metering system 100 can leverage this message passing capability by establishing predetermined interpretations for a set of the AMI messages. The firmware system 110 at the utility meter 10 and the AMI system 50 can communicate with each other using standard AMI messaging, which the firmware system 110 can translate into instructions for operation of the utility metering system 100. The middleware system 130 can also translate or interpret AMI messages in a predetermined manner, thus translating AMI messages sent from the firmware system 110 into messages that the middleware system 130 can recognize and address. Analogously, the middleware system 130 can communicate with the firmware system 110 through the AMI system 50. When the middleware system 130 has a message (e.g., an instruction) for the firmware system 110, the middleware system 130 can translate the message into an AMI message and then pass the message to the AMI system 50 for forwarding to the firmware system 110.

The utility metering system 100 can establish a predetermined mapping between potential utility services system 100 messages to AMI system messages, and a predetermined mapping between AMI system messages and utility services system 100 messages. In an exemplary embodiment, these mapping are symmetrical, but this need not be the case.

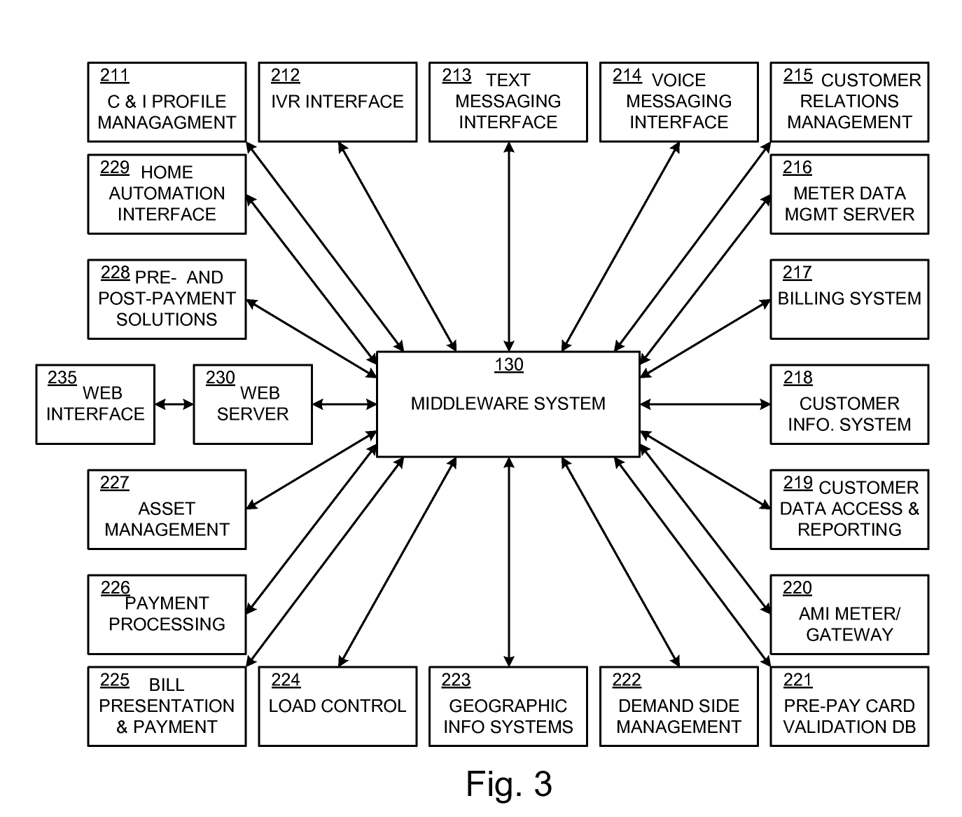

FIG. 3 illustrates a diagram of the middleware system 130 in communication with a plurality of system resources 150, according to an exemplary embodiment of the present invention. The middleware system 110 can be analogous act as a central server for the utility services system 100 and can comprise one or more computing devices or servers configured to provide centralized operations of the utility metering system 100. For example, in some embodiments, the middleware system can maintain data relevant to the system 100 as a whole, provide services for a website 235, and maintain and manage data relevant to individual customers. The middleware system 130 need not be associated with a single utility provider, but may instead provide services for multiple utility providers associated with the utility metering system 100.

As shown, system resources 150 in communication with the middleware system 130 can include, for examples only: commercial and industrial profile management 211; an interactive voice response (“IVR”) interface 212; a text messaging interface 213; a voice messaging interface 214; customer relations management 215; a meter data management server 216; a billing system 217; a customer information system 218; customer data access and reporting 219; AMI meter/gateway 220; pre-pay card validation database 221; demand side management 222; geographic information systems 223; load control 224; electronic bill presentation and payment 225; payment processing 226; asset management 227; pre-pay and post payment solutions 228; a home automation interface 229; and a web interface 235. Other system resources may also be utilized by the utility services system 100.

Some of these system resources 130, including the web interface 235, the IVR interface 212, and the text and voice messaging interfaces 213 and 214, can be used to communicate with customers and service representatives for account management. For example, and not limitation, these system resources can be used to send notifications to customers or receive account modifications from customers via telephone, text message, voice message, website, or email.

The web interface 235 can be an interface to a website provided by a web server 230 associated with the utility metering system 100. The web server 230 can manage a web account for each customer registered with the website. Through the associated web account, a customer can manage his or her utility services account. Changes made to the web account via the website can be stored on the middleware system 130 and used to update the customer's utility services account. As needed, these updates can then be transmitted from the middleware system 130 to the applicable firmware system 110 at the customer's utility meter 10, such as by message-passing through the AMI system 50. Accordingly, a customer can be in communication with his associated utility meter 10 through the website.

Because the customer can access his or her utility meter 10 through the website, account changes made on the website can automatically and immediately affect the utility meter 10. For example, and not limitation, if the customer makes a payment through the website, the payment information can be transmitted to the firmware system 110 at the applicable utility meter 10. After receiving notification of the payment, the firmware system 110 can apply one or more stored rules to determine how to respond to the payment. If the customer's utility service is currently disconnected, for example, and the payment brings the customer's balance to a positive value, the firmware system 110 and the utility meter 10 can automatically reconnect the utility service. The reconnection can occur in real time when the customer makes the payment. This is a drastic improvement over conventional systems, in that no service representative is required to physically visit the utility meter 10 to reconnect the utility service. Accordingly, the utility service provider can save money by sparing its personnel, and the customer can benefit from immediate service reconnection.

Payments made by the customer via the text or voice message interfaces or via the IVR system can likewise affect the firmware system 110, and thus the utility meter 10, in real time. Accordingly, payments or other account management actions taken through these interfaces can also be passed to the firmware system 110 and addressed by the rules of the firmware system 110.

Various account management actions can be taken by customers or service representatives through the user interfaces (e.g., web interface 235, text message interface 213, voice message interface 214, and IVR 212) of the utility metering system 100. Through these interfaces, payments can be made by customers by various methods, including credit card, debit card, branded Visa® or MasterCard® card, stored value card gift card, open or closed Loop rechargeable card or gift card, MoneyGram®, Ace® check cashing, reloadable card, or certified payment. In addition to payments, these interfaces can also enable customers to change their rate plans, billing preferences, notification preferences, or other aspects of their accounts. These changes can be communicated to the applicable firmware systems 110, where they can be encapsulated in rules used by the firmware systems 110.

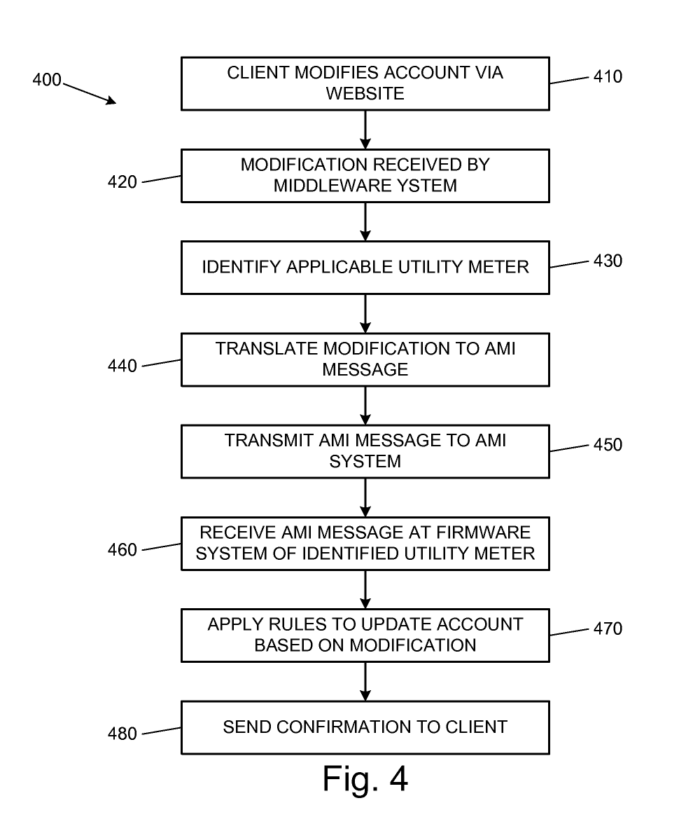

FIG. 4 illustrates an exemplary utility metering method 400, according to an exemplary embodiment of the present invention. As shown in FIG. 4, a customer can modify to his or her account through the website 235 of the utility metering system 100 at 410. At 420, this modification can be received by the middleware system 130. At 430, middleware system can identify the utility meter 10 applicable to the account modification. At 440, the account modification can be translated into an AMI system 50 message by the middleware system 130. At 450, the middleware system 130 can transmit the AMI message that encapsulates the account change to the AMI system 50. At 460, the AMI system 50 can transmit the AMI message to the firmware system 110 at the applicable utility meter 10. At 470, the firmware system 110 can apply one or more rules that are relevant to the account modification. At 480, the website 235 can confirm the account modification to the customer. It will be understood that some embodiments of the method 400 can differ from the embodiment shown, and that various utility metering methods can be provided for or by the utility metering system 100.

Accordingly, as described above, various embodiments of the utility metering systems and methods can thus provide efficient, automated account services with increased accuracy and reduced intervention by utility services personnel.

While the utility metering system and method have been disclosed in exemplary forms, many modifications, additions, and deletions may be made without departing from the spirit and scope of the system, method, and their equivalents, as set forth in the following claims.

What is claimed is:

1. A utility metering system comprising:
a firmware system located proximate a customer premise of a customer and in communication with a utility meter, the firmware system being configured to maintain, proximate the customer premise, rate information and an account balance for a utility account of the customer, the firmware system comprising:
a rules unit for applying a set of one or more rules associated with a utility account of the customer; and
a calculations unit configured to update the account balance stored proximate the customer premise in real time, based on usage of a utility service detected by the utility meter.

2. The utility metering system of claim 1, further comprising a middleware system in remote communication with the firmware system, the middleware system configured to receive an account modification request and to communicate the account modification request to the firmware system proximate the customer premise.

3. The utility metering system of claim 2, the middleware system and the firmware system being in communication over an automated metering infrastructure.

4. The utility metering system of claim 3, the firmware system being installed on the utility meter by the automated metering system.

5. The utility metering system of claim 1, the firmware system being configured to update the account balance at periodic intervals of approximately one minute or less.

6. The utility metering system of claim 1, the firmware system being configured to automatically disconnect the utility service in response to the account balance being less than a predetermined threshold.

7. The utility metering system of claim 1, the firmware system being configured to automatically reconnect the utility service in response to the account balance being greater than a predetermined threshold.

8. The utility metering system of claim 1, the firmware system being configured to automatically and independently modify the utility service provided to the customer without external approval.

9. The utility metering system of claim 1, the firmware system being configured to automatically notify a party of a status of the utility account, in response to a predetermined condition being met.

10. The utility metering system of claim 9, the party notified being the customer.

11. The utility metering system of claim 1, the set of one or more rules being customized for the customer.

12. A utility metering system comprising:
a plurality of firmware systems, each firmware system being located proximate a customer premise in communication with a corresponding utility meter, and being configured to store proximate the customer premise a plurality of rate information and a plurality of balance information related to a utility account of a customer associated with the corresponding utility meter;
a middleware system in remote communication with the plurality of firmware systems, the middleware system configured to receive an account modification request from a first customer associated with a first firmware system in communication with a corresponding first utility meter; and
the first firmware system being configured to update a first utility account of the first customer directly on the first firmware system, in response to the account modification request.

13. The utility metering system of claim 12, the first firmware system being configured to calculate an updated account balance of the utility account, proximate the customer premise, in response to the account modification request.

14. The utility metering system of claim 12, the first firmware system being configured to modify the rate information stored proximate the customer premise, in response to the account modification request.

15. The utility metering system of claim 14, the first firmware system being configured to detect utility service usage and to calculate an account balance of the utility account in real time proximate the customer premise, based on the modified rate information.

16. The utility metering system of claim 12, each of the plurality of firmware systems being configured to independently calculate account balances for their corresponding utility meters.

17. A utility metering method comprising:
receiving at a middleware system a modification request for a utility account, the utility account being associated with a utility meter;
transmitting the modification request to a firmware system located proximate a customer premise of a customer and in communication with the utility meter;
storing at the customer premise a plurality of account data describing the utility account; and
configuring a processing device at the utility meter to modify the plurality of account data at the customer premise and, without approval outside of the firmware system, to determine a response to the modification request.

18. The utility metering method of claim 17, further comprising:
detecting an amount of utility service usage at the utility meter; and
applying a rate plan to calculate an updated account balance proximate the customer premise.

19. The utility metering method of claim 18, further comprising automatically reconnecting the utility service in real time if the utility service is currently disconnected and the updated account balance exceeds a predetermined threshold.

20. The utility metering method of claim 18, further comprising updating the account balance in real time when the utility service usage is detected.
